(19) United States
(12) Patent Application Publication
(10) Pub. No.: US 2017/0113326 A1
(43) Pub. Date: Apr. 27, 2017

(54) FAN NOZZLE

(71) Applicant: Phuong Taylor Nguyen, Richmond, TX (US)

(72) Inventor: Phuong Taylor Nguyen, Richmond, TX (US)

(21) Appl. No.: 14/920,689

(22) Filed: Oct. 22, 2015

(51) Int. Cl. B24C 5/04; B05B 1/04

(52) U.S. Cl. CPC B24C 5/04; B05B 1/044

(57) ABSTRACT

A fan nozzle for cleaning a surface with an abrasive blast media is constructed of a longitudinal body having an axial pathway through which the media is passed under pressure for release from a substantially rectangular cross-sectional outlet to release the media in a substantially flat, wide path. A first transition zone provides a conversion in the axial pathway from the inlet cross-section to the substantially rectangular cross-section of the outlet opening. A second transition or convergence zone first reduces and then expands the cross-section of the axial pathway for providing a Venturii acceleration of the media as it passes through the nozzle. The transition zone and the convergence zone may be coexistent along a portion of the axial pathway.

### CROSS REFERENCE TO RELATED APPLICATION

This application is a continuation of applications U.S. Ser. No. 12/012,419 and U.S. Ser. No. 12/711,920 for Fan Nozzle, filed on Feb. 1, 2008 and Feb. 24, 2010, respectively. These prior applications are incorporated by reference herein and priority is claimed.

### BACKGROUND OF THE INVENTION

Field of the Invention

The subject invention relates generally to nozzles for releasing abrasive filedia under pressure and is specifically directed to a fan nozzle for releasing the abrasive media in a wide, flat path.

Discussion of the Prior Art

Fan nozzles are relatively well known in “the industry and are used to release an abrasive media under pressure in a substantially wide, flat path instead of in a circular pattern as with nozzles with round openings. Such nozzles are particularly convenient when the abrasive media is being used to clean a large surface and it is desirable to pass the nozzle over the surface in sweeping motions.

Typically, such nozzles are adapted to be connected to a common source of pressurized abrasive media, which normally is a coupler on the end of a hose of circular cross-section. “The circular cross-section of the inlet end of the nozzle is then in communication with a convergence zone wherein the cross-section of the nozzle is less than the cross-section of the inlet of the nozzle or the outlet of the pressure source. When the media passes through the convergence zone the velocity of the flowing media accelerates as the media is introduced into the larger cross-section of the rectangular outlet of the nozzle, caused by the Venturii effect of passing the media through the reducing and then expanding zones.

Such nozzles have been around for many years. Some typical examples are shown and described in U.S. Pat. Nos. Re. 34,584; 5,704,825 and 6,626,738. Each of these patents use a Venturii-type convergence zone for reducing and then expanding the cross-sectional area of the nozzle to cause acceleration of the media as it is expelled through the nozzle outlet.

While such nozzles may be useful for the intended purpose of providing a pressurized blast media in a flat path for cleaning surfaces, they all have a common drawback. Specifically, the prior art nozzles provide for an immediate transition from a generally circular inlet cross-section to a generally rectangular outlet cross-section. This creates wear points at the transition, as well as turbulence. In addition, such a configuration creates hotspots in the media flow as the media is released from the nozzle.

With specific reference to U.S. Pat. No. Re. 34,854, it will be noted that the convergence section has an inlet end that is of a rectangular cross-section, such inlet end being adapted to connect directly to the coupler of circular-cross section. This provides for an immediate transition from a circular source to a rectangular nozzle pathway, creating a wear point at the transition as well as generating turbulence in the blow. The Venturii convergence zone is all of rectangular cross-section.

The blast nozzle of U.S. Pat. No. 5,704,825 also shows an immediate transition from a circular inlet to a rectangular convergence zone and has the same drawbacks as the nozzle of U.S. Pat. No. Re. 34,854.

The fan nozzle shown in U.S. Pat. No. 6,626,738 shows a circular cross-section Venturii in communication with the inlet end of the nozzle. Specifically, the inlet is circular and transitions into an ellipse prior to an expanding rectangular fan nozzle outlet. While an improvement over earlier designs, this still does not overcome the hot spots typically present in a fan nozzle.

### SUMMARY OF THE INVENTION

The subject invention is a fan nozzle for cleaning a surface with an abrasive blast media. The nozzle is constructed of a longitudinal body having an axial pathway through which the media is passed under pressure for release from a substantially rectangular cross-sectional outlet to release the media in a substantially flat, wide path. Within the body of the nozzle and along its axial pathway there is a transition zone providing a conversion in the axial pathway from the inlet circular cross-section to the substantially rectangular cross-section of the outlet opening.

There is also a second transition zone or convergence zone within the body of the nozzle and along the axial pathway intermediately of the inlet end and the outlet end for first reducing and then expanding the cross-section of the axial pathway within the longitudinal body for providing a Venturii acceleration of the media as it passes through the nozzle. In the preferred embodiment: of the invention the transition zone and the convergence zone are coexistent along a portion of the axial pathway.

The convergence zone may reduce the cross-sectional area of the axial pathway in a plane parallel to the release path. Alternatively, the convergence zone may reduce the cross-sectional area in a plane perpendicular to the release path. In addition, where desired, the convergence zone may reduce the cross-sectional area of the axial pathway in planes both parallel to the release path and perpendicular to the release path.

In the preferred embodiment of the invention the nozzle comprising the longitudinal body, including the inlet end, the outlet end and the transition zone and the convergence zone may be of unitary construction.

By providing the transition zone in accordance with the subject invention the media flow is converted from a flow of circular cross-section to a flow of rectangular cross-section over a longitudinal path. This provides a smooth transition and minimizes both the turbulence and wear. In addition, by providing a smooth transition, the abrasive particles are more evenly distributed throughout the flow area cross-section whereby the hot spots in the media flow outlet are substantially reduced.

The transition zone is used in combination with a convergence zone to both convert the cross-sectional pattern of the flow and accelerate the flow to provide improved fan nozzle performance with a desirable wide, flat: path with a minimum of hot spots. This permits more even flow of the media and more even cleaning or preparation of the surface being treated.

In the preferred embodiment of the invention, the convergence zone and the transition zone are coexistent along the longitudinal media flow path. However, it is not necessary that the zones be coexistent.

Also, the subject invention incorporates a convergence zone which can intersect the flow path in a plane parallel to the fan nozzle outlet, or a plane perpendicular to the fan nozzle outlet, or both parallel and perpendicular depending on preference.

The fan nozzle of the subject: invention produces a desirable wide, flat media flow with a minimum of hotspots making it useful for a large variety of applications. The features of the invention will be made more apparent by reference to the accompanying drawings and detailed description.

### BRIEF DESCRIPTION OF THE DRAWINGS

FIG. 1 is a perspective view of the fan nozzle of the subject invention.

FIG. 2 is a diagrammatic view of the axial pathway of the nozzle, diagrammatically illustrating the relationships of the cross-sectional areas of the interior of the nozzle throughout its length.

FIG. 3 is a slice view of the nozzle looking from the inlet toward the outlet.

FIG. 4 is a slice view of the nozzle, looking down on the nozzle in a plane perpendicular to the plane of the fan expansion section.

FIG. 5 is a sectional view taken along line 5-5 of the slice view of FIG. 3.

FIG. 6 is a cross-sectional view of the nozzle taken along line 6-6 of FIG. 1.

FIG. 7 is a top view of the nozzle showing in phantom the axial passageway.

FIG. 8 is a top view of an alternative embodiment of the nozzle, showing in phantom a modified axial passageway.

FIG. 9 is a diagram showing the flow through a nozzle in accordance with the subject: invention.

FIG. 10 is a diagram contrasting the flow through a prior art nozzle configuration.

### DETAILED DESCRIPTION

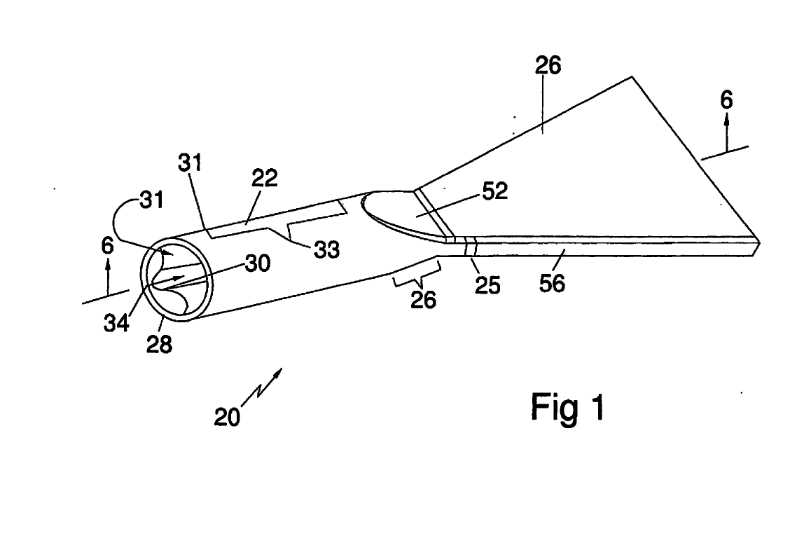

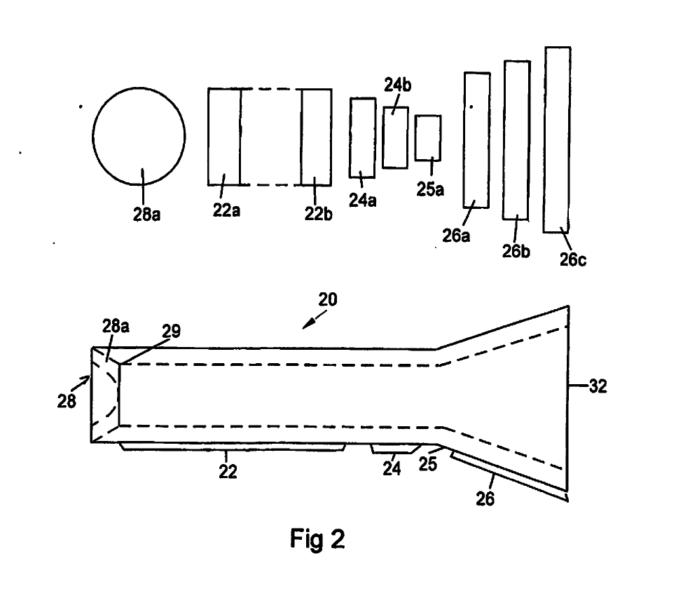

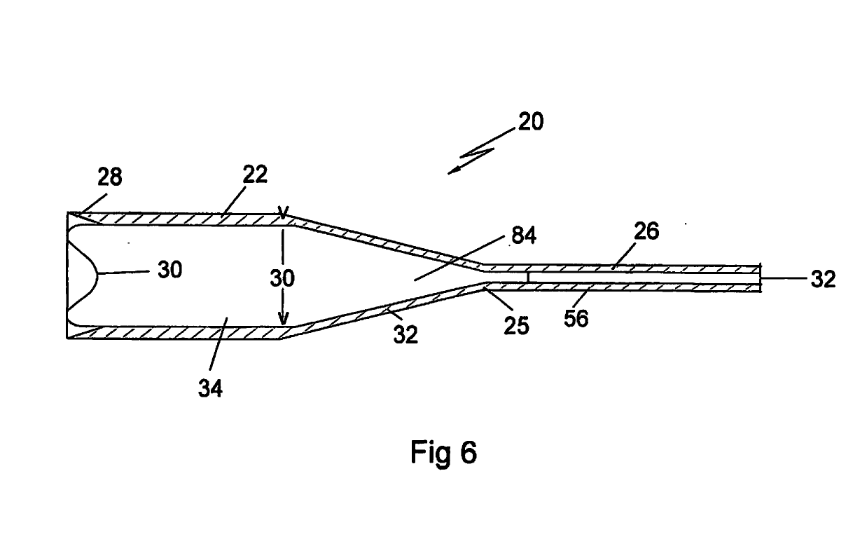

With specific reference to FIG. 1, the fan nozzle of the subject invention comprises a longitudinal body 20. The fan nozzle is divided into three main sections, the inlet section 22, the transition section 24 and the expansion section 26. A cross-sectional view of the nozzle, taken along line 6-6 of FIG. 1 is shown in FIG. 6. The inlet 28 of the nozzle is adapted to be coupled to a source of pressurized media and is typically of a generally circular cross-section, but may be modified, as at 30, to receive a connector on the source (not shown). Inwardly of the inlet 28, the inlet section 22 is of a rectangular cross-section, as shown in FIGS. 2-5, for distributing the pressurized air or other fluid and the abrasive throughout the full cross-sectional area of the nozzle. Specifically, the inlet end 28 of the nozzle provides a transition from the circular connector at 28a to a rectangular cross-section at 31, with the remainder 33 of the inlet section being of rectangular cross-section. An axial pathway extends the entire length of the nozzle assembly and connects the outlet 32 with the inlet 28.

The convergence transition section 24 of the nozzle flows from the inlet section 22 into a throat 25 which is the inlet to the expansion section 26. The convergence transition section provides a reduction in area of the rectangular cross-sectional flow, path in the inlet section. This provides a Venturii effect for accelerating the fluid/abrasive mix. The throat determines airflow consumption. As shown in FIGS. 2-5, the entire convergence transition section is of continuously reducing, rectangular cross-section. The expansion section 26, also of rectangular cross-section, then “fans out” or expands in one plane and terminates in a rectangular, flat outlet 32. This provides full divergence of the fluid/media mix across the entire cross-sectional area of the outlet 32 for dispersing the mix onto a target object.

As better shown in FIG. 2, the inlet 28 is of a cross-section adapted to fit the source of the fluid/media flow, as shown at 28a. This is then converted to a generally rectangular cross-sectional area as shown at 22a, which extends the entire length of the inlet section 22, as indicated at 22a and 22b. The cross-sectional area is continuously reduced in the convergence transition section 24, as indicated at 24a, 24b and 25a, with the final cross-section 25a defining the nozzle throat for controlling flow. Specifically, the cross-sectional areas 22a and 22b are substantially the same for the entire length of the inlet section 22. Cross-sectional areas 24a, 24b and through to 25a are continuously reducing. Cross-sectional areas 26a, 26b and through 26c in the nozzle expansion zone are continuously increasing. The diagrammatic cross-sections above the fan nozzle illustration show the cross-sectional area configuration including circular inlet 28a, the transition to rectangular cross-section at 22a, the transition section 24, the throat 25 and the expansion section 26 terminating at the outlet 32. The sectional area 25a defines the controlling throat 25. The cross-sectional area is then expanded in the expansion section 26, as indicated at 26a, 26b and 26c.

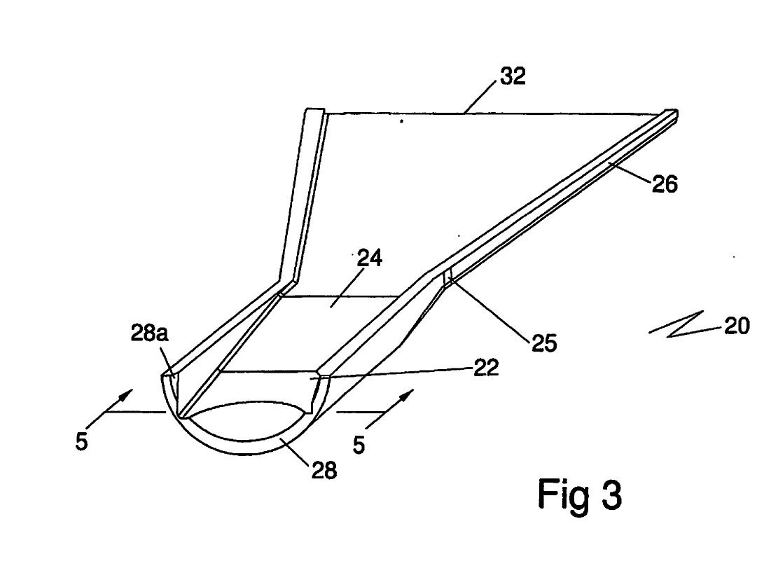

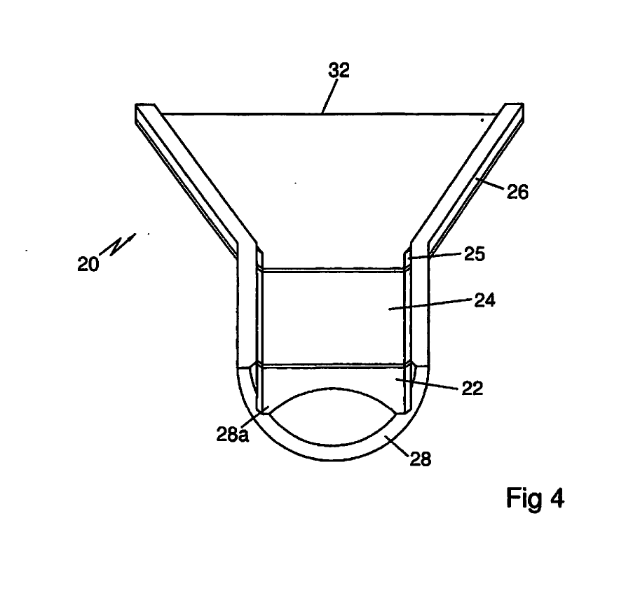

A longitudinal slice through the nozzle 20 and looking from the inlet opening 28 toward the outlet opening 32 is shown in FIG. 3. This clearly shows the relationship between the various junctions of the nozzle, with the circular-to-rectangular transition present at 28a, the rectangular cross-sectional inlet section 22, the converging transition section 24 and throat 25 terminating in the expansion section 26. This configuration permits a continuous, smooth flow of the media through the nozzle without any abrupt transition points, reducing turbulence and minimizing wear. It also permits the media flow to reshape itself without creating hotspots due to interruption in flow or increased resistance to flow in specific areas. Another slice view, looking down on the nozzle, is shown FIG. 4.

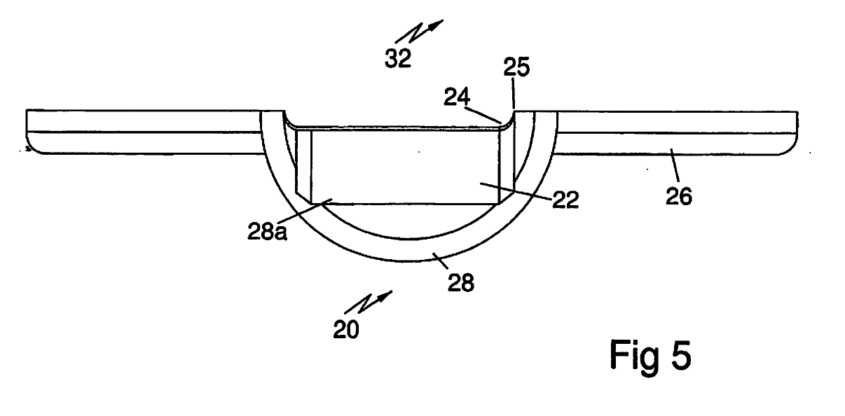

FIG. 5 is an end view of the nozzle taken at line 5-5 of FIG. 3 and looking in the direction from the inlet 28 toward the outlet 32. This shows the relationship between the inlet 28, the transition 22a, the inlet section 22, the convergence transition section 24, the throat 25, the expansion section 26 and the outlet 32.

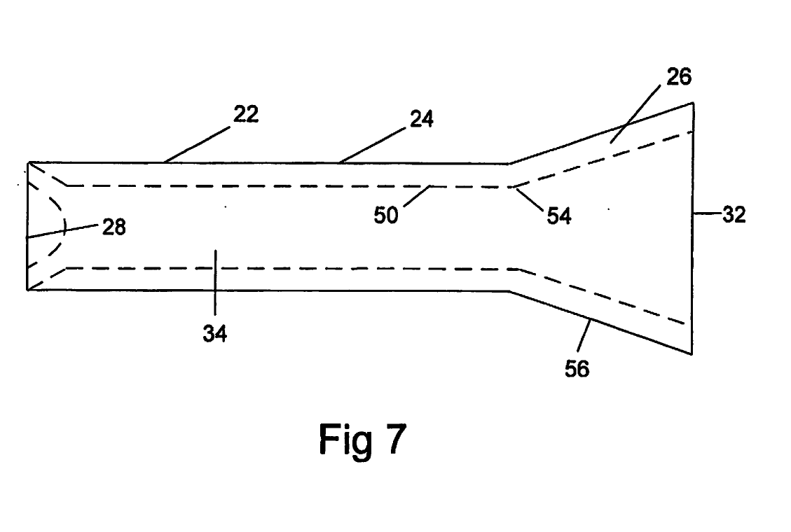

As better shown in FIGS. 6 and 7, the convergence transition section 24 begins with the full cross-sectional area 50 at the junction between the inlet section 22 and the convergence section 24. The cross-sectional area is continually reduced by the tapered wall 52 of the body, as indicated in FIGS. 1, 6 and 7, terminating at the throat 25. Then beginning at the throat outlet 54 the cross-section continually increases in a plane substantially perpendicular to the converging plane of the transition section, as indicated by the outward fanning or tapered wall 56 of the nozzle. This creates a Venturii effect acceleration of the media as it flows through the nozzle and is expelled through outlet 32.

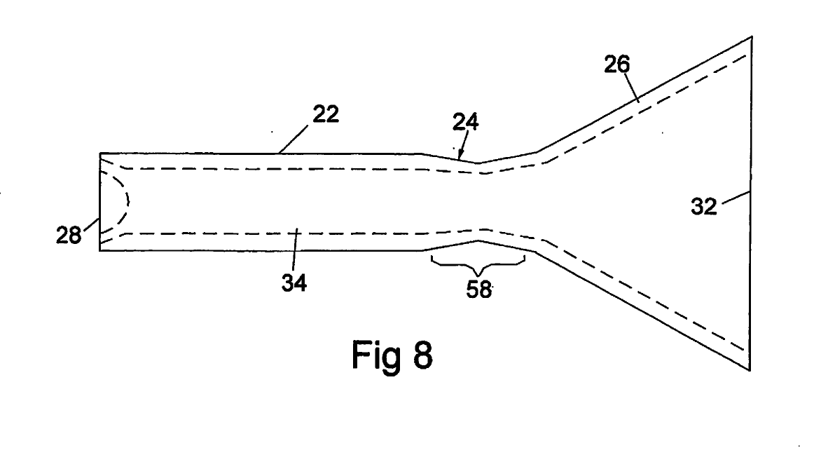

The transition section of the embodiment of FIGS. 1, 6 and 7 is in a single plane running parallel to the opening 32 in nozzle 26. An alternative embodiment is shown in FIG. 8. In this configuration, the convergence section 48 is perpendicular to the plane of the nozzle 26. However, in function it operates in the same manner as the configuration of FIGS. 1 and 6. Namely, the cross-section of the convergence section is the same as the inlet section at junction 60, and reduced by the tapered wall 62 to the junction 64 between the convergence section 58 and the nozzle 26. The cross-section then expands in the tapered fan nozzle section 26, again creating a Venturii effect acceleration of media toward the nozzle outlet 32.

The two configurations of the convergence section may be used independently of one another, or in combination. Also, while the convergence section(s) and the transition section 24 are shown as longitudinally separated in the illustrated embodiments, it should be readily understood by those who are skilled in the arts that these two sections could be coexistent along the flow path of” “the nozzle. By placing them in a coexistent position, the nozzle can be of a more compact design.

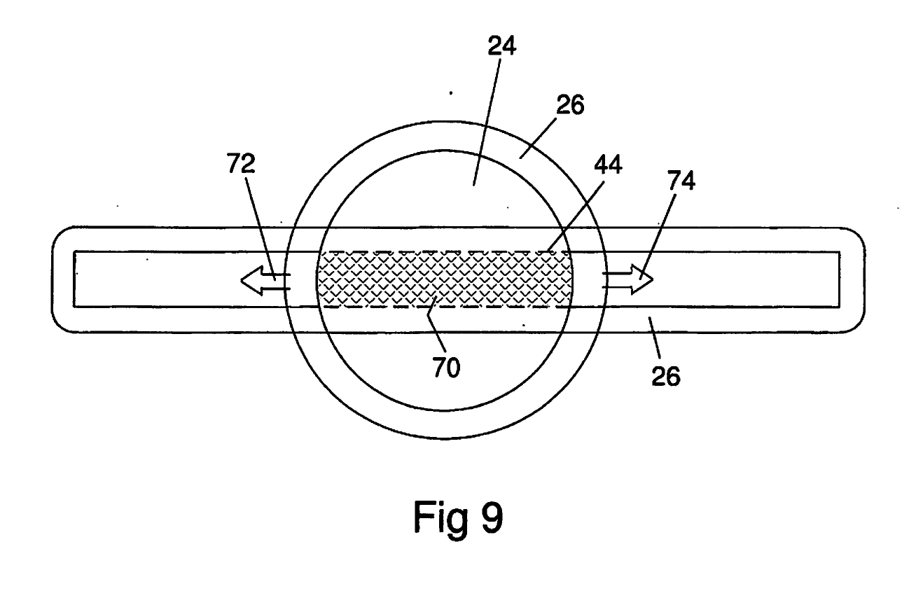

The flow path of a nozzle in accordance with the present invention is graphically shown in FIG. 9. As can be seen, once the media flow enters the nozzle 26 at the transition/nozzle junction 44, all of flow has been smoothly converted into a rectangular cross-section and is confined in the shaded area 70. Then, because of the Venturii effect of the convergence zone, the flow only has to expand and accelerate outwardly as indicated by arrows 72 and 74.

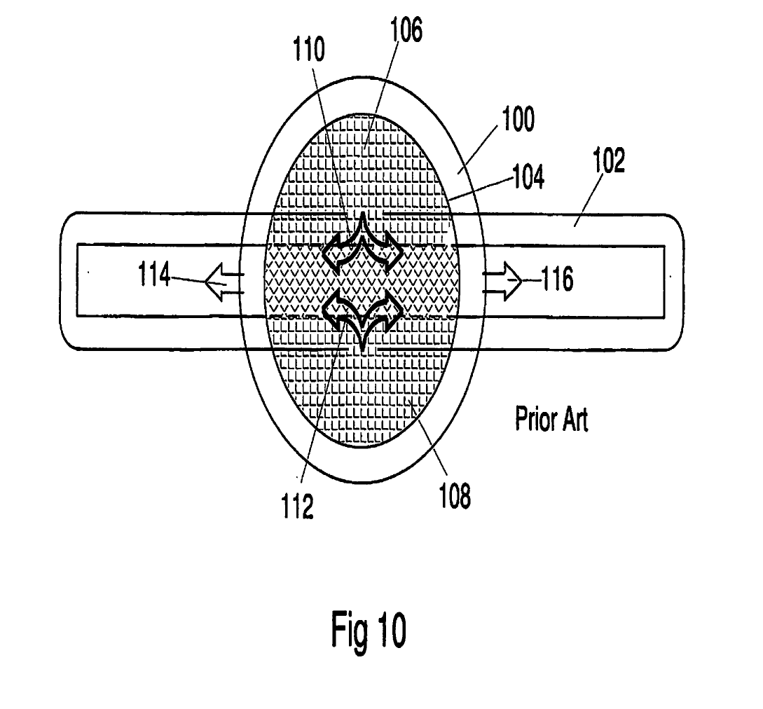

This is to be contrasted with the prior art designs, as graphically illustrated in FIG. 10. In these configurations, there is an abrupt change in shape at the junction between the inlet section 100 and the rectangular nozzle section 102. This is true even when a Venturii accelerator is used and the cross-section is reduced as indicated at: 104. This results in some of the flow being trapped at the end of the convergence section when the convergence section is of circular cross-section, as indicated at 106 and 108. The media flow then must travel in a direction perpendicular to the flow outwardly into the nozzle, as indicated at 110 and 112. This results in turbulence, a wear point in the nozzle and hotspots in the flow as more of the media volume is in the areas of the arrows 110 and 112 and less of the media volume is in the area of the outer arrows 114 and 116.

The transition section of the nozzle of the subject invention minimizes turbulence, reduces wear and provides for a more even flow. When used in combination with a convergence section, the fan nozzle of the subject invention provides a smooth, wide, flat flow of media with a minimum of hot spots. While certain features and embodiments of the invention have been described in detail herein, it should be understood that the invention includes all modifications and enhancements within the scope and spirit of the following claims.

What is claimed is:

1. A nozzle for cleaning a surface with an abrasive media flow, the nozzle comprising:
a. a longitudinal body having an axial pathway therethrough, an inlet end of generally circular cross-section and adapted to be connected to a source wherein the abrasive media flow is introduced into the nozzle under pressure, the inlet end of a cross-section compatible with the cross-section of the source at the point where the media flow is introduced into the nozzle;
b. an outlet end having an opening of a flat, substantially rectangular cross-section for releasing the abrasive media flow in a wide substantially flat path;
c. a first transition zone between the inlet end and the outlet end, the first transition zone providing a conversion in the axial pathway from the inlet cross-section to the substantially rectangular cross-section of the outlet opening along a portion of the longitudinal body, the first transition zone being of a constant substantially rectangular cross-section throughout its length and of a length for permitting minimization of turbulence in the flow before releasing the flow into the outlet end; and
d. a second transition zone for reducing the substantially rectangular cross-sectional area of the first transitional zone intermediately of the inlet end and the outlet end.

2. The nozzle of claim 1, wherein the first transition zone and the second transition zone are in axial alignment along the axial pathway within the longitudinal body.

3. (canceled)

4. (canceled)

5. The nozzle of claim 2, wherein the second transition zone extends along a portion of the axial pathway within the longitudinal body and first reduces the cross-section of the axial pathway within the longitudinal body.

6. The nozzle or claim 1, further including an expansion zone between the second transition zone and the outlet for diverging and discharging the media.

7. The nozzle of claim 5, further including an expansion zone between the second transition zone and the outlet for diverging and discharging the media.

8. (canceled)

9. (canceled)

10. (canceled)

11. The nozzle of claim 1, wherein the longitudinal body, including the inlet end, the outlet end and the first transition zone and the second zone are of unitary construction.

12. The nozzle of claim 1, wherein the second transition zone reduces the cross-sectional area of the axial pathway within the longitudinal body in a plane parallel to the release path.

13. The nozzle of claim 1, wherein the second transition zone reduces the cross-sectional area of the axial pathway within the longitudinal body in a plane perpendicular to the release path.

14. The nozzle of claim 1, wherein the second transition zone reduces the cross-sectional area of the axial pathway within the longitudinal body in a plane parallel to the release path and in a plane perpendicular to the release path.
